(19) United States
(12) Patent Application Publication
(10) Pub. No.: US 2002/0138570 A1
(43) Pub. Date: Sep. 26, 2002

(54) System for and method of automatically migrating data among multiple legacy applications and accessible storage formats

(76) Inventor: Neil Hickey, Golden, CO (US)

Correspondence Address: Sam Pasternack, Choate, Hall & Stewart, 53 State Street, Exchange Place, Boston, MA, 02109, US

(21) Appl. No.: 09/815,805

(22) Filed: Mar. 23, 2001

(51) Int. Cl. G06F 15/16; G06F 15/173

(52) U.S. Cl. 709/204; 709/226

(57) ABSTRACT

A system for and method of automatically migrating data among multiple legacy applications and accessible storage formats. The various embodiments described employ a trainable user interface translator application to monitor, reinterpret, and reformat data streams. The sequences of steps necessary to migrate data are recorded in a shaper rule set during a training session. Automatic migration of data is accomplished by operating the trainable user interface translator application in normal run mode in accordance with a shaper rule set previously created during the training session.

### FIELD OF THE INVENTION

The present invention relates generally to providing a means to automatically transfer data between multiple existing host applications (legacy systems) and between existing host applications and storage formats making the application data accessible to other applications that was otherwise inaccessible. More specifically, the invention achieves these objectives by monitoring, reinterpreting and reformatting data streams according to rule sets established during training sessions using normal operating and exception training data sets.

### BACKGROUND OF THE INVENTION

Businesses often need to transfer data between existing applications. For example, companies frequently need to migrate data between the computer systems of individual business units. Similarly, corporations often need to quickly transfer large amounts of data when undergoing a merger acquisition. Further, the increasing use of application service providers requires the transfer of large amounts of data. In all of these cases, the type of data transferred is often sensitive in nature and might include client data, inventory data, sales data, and account data. Data transfer is typically performed manually - a labor-intensive, costly and error-prone process. Alternatively, low-level code is sometimes created to accomplish data transfers. However, this approach involves a risk of corrupting one or all of the affected systems. Mitigating the risk of system damage requires extensive and costly testing procedures before installing such transfer code. The increasing amount of business conducted on existing applications requires efficient, expedient, non-invasive, and secure data transfer methods.

Electronic business-to-business transactions require a data transfer mechanism. For example, a trading network that contains a centralized administration system with peripheral trading companies needs a data “bridge” between the central system and peripheral companies. It is over this data bridge that business data such as ordering, shipping, and billing information is transferred. In such an arrangement, sales information may arrive on one system and subsequent billing information may be generated by a separate system, which often leads to inefficient business operations. What is needed is a way to increase the efficiency of business operations.

Transferring data between multiple systems is very costly with conventional methods, particularly when they require in-depth data analysis, custom programming, or manual data transfer methods. When it is a one-time event (e.g., when replacing one system with another system), data transfer may also be cost-ineffective due to the high cost of preparation and execution. What is needed is a way to cost-effectively transfer data from one system to another.

Data transfer between computer systems often must be performed quickly. For example, when financial institutions merge, client and account information may need to be transferred in the space of one weekend so that clients experience no interruption in service. Mergers and acquisitions of this type can arise with little or no notice, reducing the amount of time that an organization has available to prepare for data transfer. Additionally, there are numerous regulatory requirements that limit the amount of time permitted for merging businesses to combine their respective data and computer systems. What is needed is a way to transfer data from one system to another in a timely manner.

Data transferred from one system to another must be properly formatted and consistent. If the data being transferred is not properly formatted, there is a risk that the transferred data may corrupt data on one or all of the affected systems. What is needed is a way to safely transfer data from one system to another.

Data existing on two or more business systems must be synchronized in order to assure accurate tracking, pricing, and delivery. To achieve this, separate computer systems must be able to coordinate a transfer of data. For example, sales data may reside on one system, a second system may process inventory data, and a third system may process shipping data. When a product is sold via the sales system, the inventory must be updated. Simultaneously, the sales system must alert the shipping system to produce a shipping label. The success of the business therefore depends on the synchronization of data in each of the individual systems. What is needed is a way to synchronize the data residing on multiple existing systems.

During a data transfer event, data from one system must often be validated against data from a second system. To achieve this, the business logic resident on one system must be made accessible to the second system. For example, one system may be an order entry system while a second system calculates the product shipping rates. In order to calculate an accurate product cost for a customer, the order information from the first system must be transferred to the second system. The business logic on the second system must calculate the shipping cost and transfer this data back to the order entry system. Manual methods of performing such data transfers and calculations are inefficient and error prone. What is needed is a way to validate data residing on one system against data residing on a second system while utilizing the business logic of both systems.

One way to approach the above needs is to create an entirely new application with similar functionality. However, this approach is costly, time consuming, and error prone. The data could also be transferred manually between the host applications and/or between a host application and any intermediate storage medium, but this approach is labor intensive, costly, and error prone. Another way of solving the same problems is to programmatically transfer the data while bypassing the host applications, however this approach does not allow for error checking or the execution of the business logic inherent to the host applications.

### SUMMARY OF THE INVENTION

The present invention is a system for and method of automatically migrating data among multiple existing applications and storage formats providing access to the applications to otherwise inaccessible data. The embodiments described below share the ability to monitor, reinterpret, and reformat data streams by means of a shaper computer operating a software training application. The techniques employed in the current invention build upon “trainable user interface translator” technology (referred to below as “TeleShaper” technology) as described in U.S. Pat. Nos. 5,627,977 and 5,889,516, which are assigned to the assignee of the present application and which are hereby incorporated by reference in their entirety into the present application.

In a first embodiment, the invention is a trainable system for automatically transferring data between multiple existing applications, comprising a shaper computer operating a trainable user interface translator application and storing a shaper rule set and control variables, a training terminal electrically connected to the shaper computer, a first host computer electrically connected to the shaper computer and operating at least one first host application, and a second host computer electrically connected to the shaper computer and operating at least one second host application. Either or both of the host computers may be remote computers operating remote host applications. The shaper computer monitors the data streams of the at least one first host application and, according to the shaper rule set and list of control variables established during the training session, reinterprets and transmits automatically the data identified by the control variables to the at least one second host application.

In another aspect, the invention is a method of training and using the trainable system to transfer data between multiple host applications. Employing the apparatus described in the previous paragraph, the method comprises the steps of defining input and output variables, defining one or more control variables, selecting sample data values for the control variables, starting a training mode on the training terminal, exercising the first host computer with the sample data values, storing output from the first host computer, exercising the second host computer with the output data, storing output from the second host computer, if any, determining if the business process is complete, and determining if there are additional sample data values to process. The training session data sets should include normal operating data and exception data to allow the trained system to programmatically correct errors and exceptions within existing applications.

In a second embodiment, the invention is a trainable system for migrating data from an existing application to a storage format making data accessible to other applications that is otherwise inaccessible to those other applications. The trainable system comprises a shaper computer operating a trainable user interface translator application and storing a shaper rule set and control variables, a training terminal electrically connected to the shaper computer, a host computer electrically connected to the shaper computer and operating at least one host application, and an auxiliary storage device electrically connected to the shaper computer, wherein the shaper computer monitors the data streams of the at least one host application and, according to the shaper rule set and list of control variables established during the training session, reinterprets and transmits automatically the data identified by the control variables to the auxiliary storage device.

In another aspect, the invention is a method of training and using the trainable system to transfer data between multiple host applications. Employing the apparatus described in the previous paragraph, the method comprises the steps of defining input and output variables, defining a control variable, selecting sample data values for the control variable, starting a training mode on the training terminal, exercising the host computer with the sample values, storing the output from the host computer, determining if the business process is complete, and determining if there are additional sample data values to be processed.

In a third embodiment, the invention is a system for and method of migrating data from a storage format to an existing application that cannot otherwise access the data. The system may be configured identically to the second embodiment. The difference between this embodiment and the second is the direction of data flow. Whereas in the second embodiment the trainable system is trained and then migrates data in accordance with the shaper rule set from the one or more existing host applications, in the third embodiment data is migrated from the auxiliary storage device to the one or more existing host applications. In both cases, the data being migrated would otherwise be inaccessible to the data target.

Each of the embodiments described above have the ability to provide access for users who require information from existing applications but are unable to access it. The present invention can be quickly implemented with a minimal amount of training. It obviates the need to recode existing applications in order to gain increased functionality, and can accommodate changes in the existing host applications. It can utilize the existing error checking and error handling functionality in the existing source applications. In addition, it allows the use of old access methods while accommodating updated access methods, thereby extending the life of existing computer assets.

### BRIEF DESCRIPTION OF THE DRAWINGS

FIG. 1 is a schematic diagram of a first embodiment of the present invention for automatically transferring data between multiple existing applications.

FIG. 2 is a flow diagram illustrating a method of defining a representation of data in multiple host applications and training a TeleShaper system to extract data from and insert data to these applications.

FIG. 3 is a flow diagram illustrating a method of training a TeleShaper system to automatically transfer data between multiple existing host applications.

FIG. 4 is a flow diagram illustrating a method of training a TeleShaper system to pre-fetch a list of control values to use in process 300.

FIG. 5 is a schematic diagram of a second embodiment of the present invention for migrating data to and from an existing application to a storage format accessible to other applications.

FIG. 6 is a flow diagram illustrating a method of training a TeleShaper system to migrate data from an existing application to a storage format.

FIG. 7 is a flow diagram illustrating a method of using a TeleShaper system to migrate data from an existing application to a storage format.

FIG. 8 is a flow diagram illustrating a method of training a TeleShaper system to migrate data from a storage format to an existing application that cannot otherwise access the data.

FIG. 9 is a flow diagram illustrating a method of using a TeleShaper system to migrate data from a storage format to an existing application that cannot otherwise access the data.

### DETAILED DESCRIPTION

Preferred embodiments of the invention will now be described with reference to the accompanying drawings.

### First Embodiment: Automatically Migrating Data Between Multiple Existing Applications

In one aspect, the present invention is a system for and method of automatically transferring data between multiple existing applications. The system is able to monitor and reinterpret data streams present in existing applications and, according to rules established during a training sequence, programmatically migrate data from one application to another, and handle errors and exceptions while doing so.

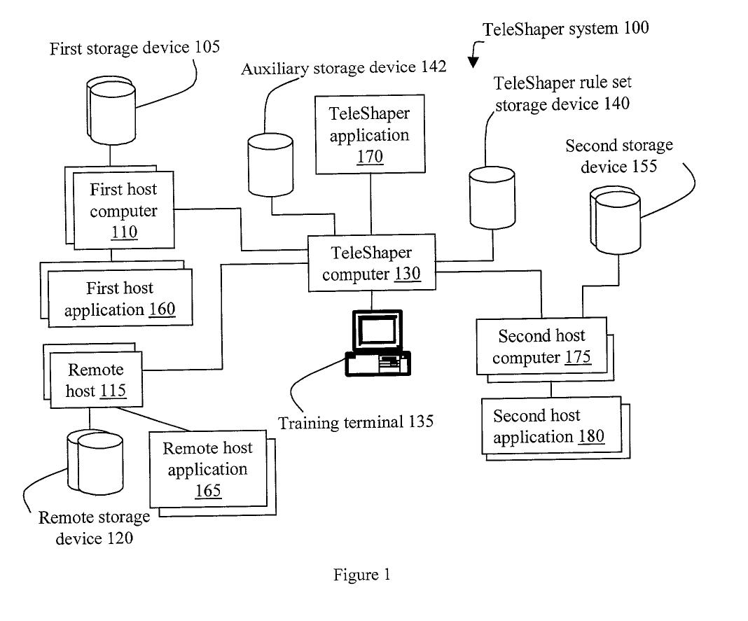

FIG. 1 is a schematic representation of a TeleShaper system 100. TeleShaper system 100 includes a TeleShaper computer 130, one or more first host computers 110, optionally one or more remote hosts 115, one or more second host computers 175, a TeleShaper rule set storage device 140, an optional auxiliary storage device 142, and a training terminal 135. First host computer 110 further includes a first storage device 105 and a first host application 160. Second host computer 175 further includes a second storage device 155 and a second host application 180. Remote host 115 further includes a remote storage device 120 and a remote host application 165. TeleShaper computer 130 further includes a TeleShaper application 170.

First host application 160 runs on first host computer 110. First host computer 110 can be any computer that contains data to be transferred to second host computer 175. Alternatively, first host computer 110 may receive data transferred from second host computer 175.

First host computer 110 and second host computer 175 may be the same computer upon which reside first host application 160 and second host application 180. TeleShaper application 170 allows the migration, in either direction, of data between first host application 160, second host application 180, and remote host application 165.

First storage device 105 contains data associated with first host application 160, and second storage device 155 contains data associated with second host application 180.

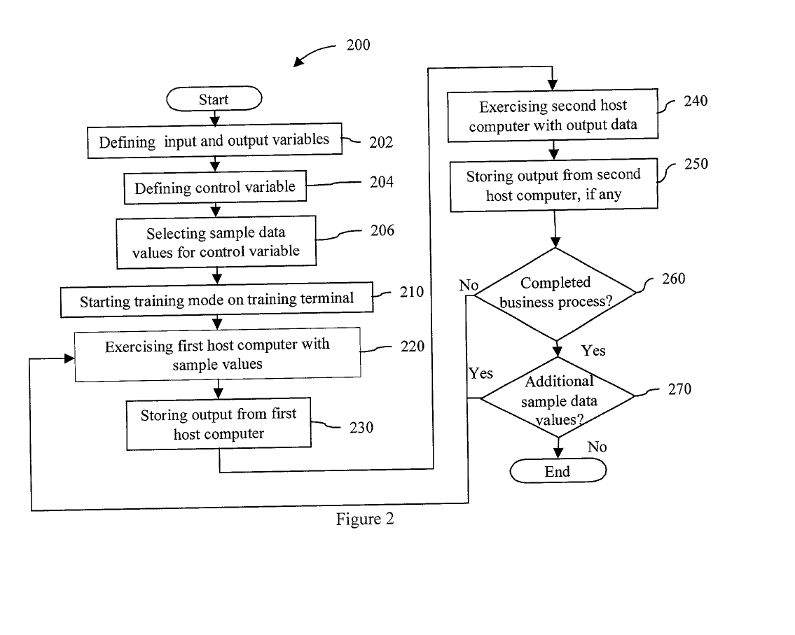

A method of training TeleShaper system 100 to transfer data between multiple host applications is now described with reference to FIG. 2.

Step 202: Defining Input and Output Variables

In this step, the trainer, operating TeleShaper computer 130 via training terminal 135, defines a text file that contains input and output variable lists associated with each step embodied in the business logic of first host application 160 or second host application 180. TeleShaper computer 130 stores the input and output variable text file on shaper rule set storage device 140.

Step 204: Defining Control Variable

In this step, the trainer, operating TeleShaper computer 130 via training terminal 135, defines a text file that contains at least one control variable associated with each step embodied in the business logic of first host application 160 or second host application 180. There may be two or more control variables. The control variable identifies the data to be transferred between first host application 160 and second host application 180. For example, a control variable named SSN may be used to store social security numbers. TeleShaper computer 130 stores the control variables text file on shaper rule set storage device 140.

Step 206: Selecting Sample Data Values for Control Variable

In this step, the trainer, operating TeleShaper computer 130 via training terminal 135, defines a text file that contains sample data values for the control variable. TeleShaper computer 130 substitutes the sample data values into the control variable as first host application 160 or second host application 180 are exercised in later steps. For example, a sample data value for the SSN variable described in step 204, might be 123-45-6789. Two types of sample data values are selected: those that generate system exceptions when operated upon, and those that do not.

Step 210: Starting Training Mode on Training Terminal

In this step, the trainer, operating TeleShaper computer 130 via training terminal 135, initiates the training mode of the TeleShaper application 170.

Step 220: Exercising First Host Computer with Sample Values

In this step, the trainer, operating TeleShaper application 170 via training terminal 135, enters a sample data value from the list of sample data values defined in step 206 and operates first host application 160 or remote host application 165 with the sample data value. First host application 160 or remote host application 165 produces resultant output data.

Step 230: Storing Output From First Host Computer

In this step, TeleShaper application 170 stores output data from first host application 160 or remote host application 165 to temporary storage.

Step 240: Exercising Second Host Computer with Output Data

In this step, the trainer, using training terminal 135 and TeleShaper application 170, utilizes the output data stored in step 230 to exercise second host application 180. This step may generate result output data from second host application 180.

Step 250: Storing Output From Second Host Computer, if Any

In this step, TeleShaper application 170 stores the output data from step 240, if any, in auxiliary storage device 142.

Step 260: Completed Business Process?

In this step, the trainer determines if TeleShaper system 100 is fully trained to accommodate the business processes associated with the transfer of data between first host application 160 and second host application 180. If no, process 200 returns to step 220; if yes, process 200 proceeds to step 270.

Step 270: Additional Sample Data Values?

In this step, the trainer determines if there are additional sample data values from that defined in step 206. If yes, process 200 returns to step 220; if no, process 200 ends.

During step 206 of process 200, two types of sample data are used to train TeleShaper system 100: exception data and non-exception data. Exception data is data that causes exceptions in the business logic in one or more of the host applications. During the training sequence embodied in process 200, TeleShaper application 170 may be trained to accommodate exception data in an appropriate manner. For example, TeleShaper application 170 may be trained to create an exception report and store it on auxiliary storage device 142 for later review or it may be trained to access additional data residing on auxiliary storage device 142 or within other aspects of host applications 160 or remote host applications 165 to find missing data.

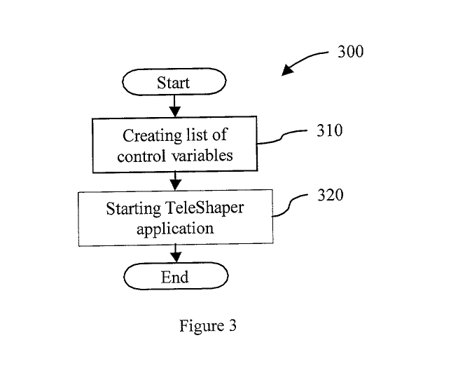

A method of training TeleShaper application 170 to automatically transfer data between multiple host applications is now described with reference to FIG. 3. Process 300 presumes that training process 200 has been completed and the results of process 200 have been stored on shaper rule set storage device 140.

Step 310: Creating List of Control Variables

In this step, the trainer, using training terminal 135, defines a list of variables via TeleShaper computer 130. TeleShaper application stores the variables on auxiliary data storage device 142.

Step 320. Starting TeleShaper Application

In this step, the trainer, using training terminal 135, starts TeleShaper application 170. TeleShaper application 170 surveys the list of control variables defined in step 310 and executes the host applications as trained during process 200.

Process 300 terminates after step 320.

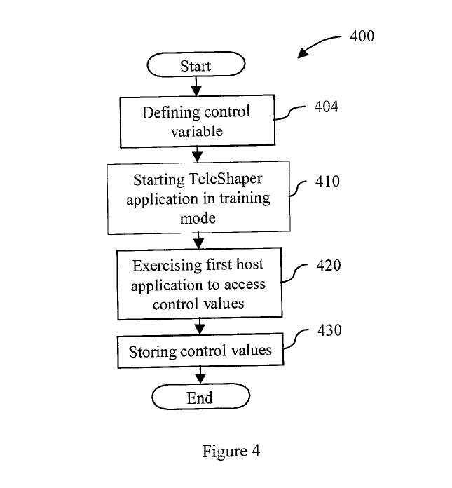

A method of training TeleShaper system 100 to pre-fetch a list of control values to use in process 300 is now described with reference to FIG. 4

Step 404. Defining Control Variable

In this step, the trainer, operating TeleShaper computer 130 via training terminal 135, defines a text file that contains the control variable associated with each step embodied in the business logic of either first host application 160 or second host application 180. There may be two or more control variables. The control variable identifies the data to be transferred between first host application 160 and second host application 180. For example, a control variable named SSN may be used to store social security numbers. TeleShaper computer 130 stores the control variable on shaper rule set storage device 140.

Step 410: Starting TeleShaper Application in Training Mode

In this step, the trainer, user training terminal 135, starts TeleShaper application 170 in training mode.

Step 420: Exercising First Host Application to Access Control Values

In this step, the trainer, using training terminal 135, exercises first host application 160 to generate a list of control values. For example, first host application 160 might have a query screen where a customer list is displayed. In this case, the customers in the list are the control values.

Step 430: Storing Control Values

In this step, TeleShaper application 170 stores the list of control values in auxiliary storage device 142.

Process 400 terminates after step 430.

The results of process 400 may be used in step 310 of process 300 (described in FIG. 3). By directly obtaining the list of control variables from first host application 160 or second host application 180, process 400 obviates the need for the trainer to manually generate the list of control values in process 300. For example, process 400 would be useful in the case where it is necessary to transfer all of the client data from one bank's computer system to another bank's computer system. In this case, process 400 would automatically generate all of the control variables necessary for account transfer. Process 400 can be performed multiple times to transfer different types of data, such as client names, client addresses, and account balances.

### Second Embodiment: Migrating Data From an Existing Application TO A Storage Format Accessible TO Other Applications

In another embodiment, the present invention is a system for and method of automatically transferring data from existing applications to an intermediate database. The system is able to monitor and reinterpret the data streams associated with one or more existing applications and, according to rules established during a training sequence, programmatically format and migrate the data from the applications to the intermediate database, from which the data may be imported to other applications.

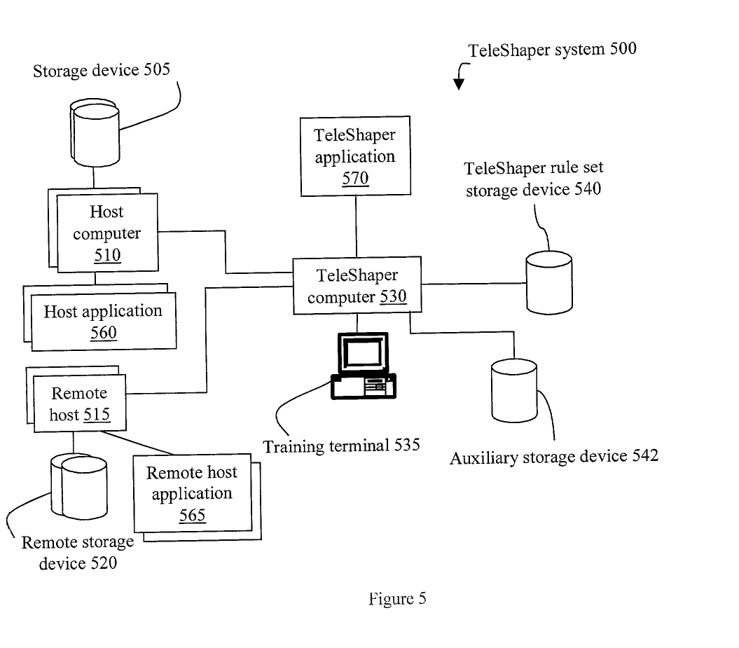

FIG. 5 is a schematic representation of a TeleShaper system 500. TeleShaper system 500 includes a TeleShaper computer 530, one or more host computers 510, optionally one or more remote hosts 515, a TeleShaper rule set storage device 540, an auxiliary storage device 542, and a training terminal 535. Host computer 510 further includes a storage device 505 and a host application 560. Remote host 515 further includes a remote storage device 520 and a remote host application 565. TeleShaper computer 530 further includes a TeleShaper application 570.

Host application 560 runs on host computer 510. Host computer 510 can be any computer that contains data to be transferred to auxiliary storage device 542.

TeleShaper application 570 allows the migration of data from host application 560 to auxiliary storage device 542, or from remote host application 565 to auxiliary storage device 542.

Storage device 505 contains data associated with host application 560, and remote storage device 520 contains data associated with remote host application 565.

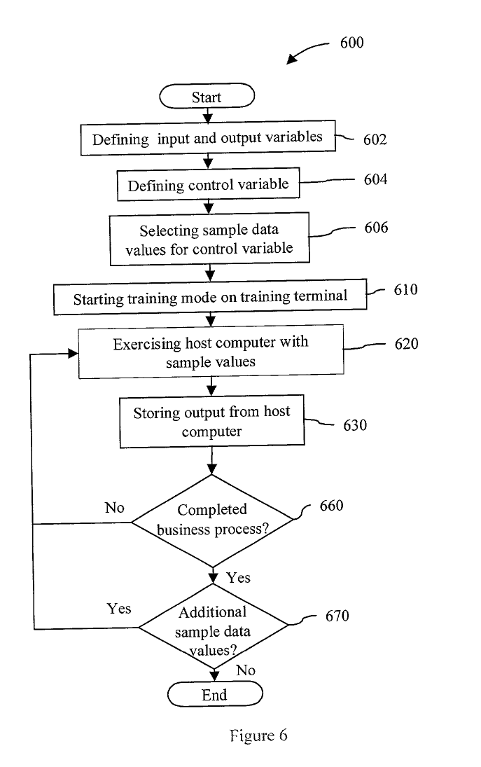

A method of training TeleShaper system 500 to transfer data from an existing application to a storage format accessible to other applications is now described with reference to FIG. 6.

Step 602: Defining Input and Output Variables

In this step, the trainer, operating TeleShaper computer 530 via training terminal 535, defines a text file that contains input and output variable lists associated with each step embodied in the business logic of either host application 560 or remote host application 565. TeleShaper computer 530 stores the variable lists on shaper rule set storage device 540.

Step 604: Defining Control Variable

In this step, the trainer, operating TeleShaper computer 530 via training terminal 535, defines a text file that contains the control variable associated with each step embodied in the business logic of either host application 560 or remote host application 565. There may be two or more control variables. The control variable identifies the data to be transferred between host application 560 and auxiliary storage device 542. For example, a control variable named SSN may be used to store social security numbers. TeleShaper computer 530 stores the control variable on shaper rule set storage device 540.

Step 606: Selecting Sample Data Values for Control Variable

In this step, the trainer, operating TeleShaper computer 530 via training terminal 535, defines a text file that contains sample data values for the control variable. TeleShaper computer 530 substitutes the sample data into the control variable as host application 560 or remote host application 565 are exercised in later steps. For example, a sample data value for the SSN variable described in step 604, might be 123-45-6789. Two types of sample data values are selected: those that generate system exceptions when operated upon and those that do not.

Step 610: Starting Training Mode on Training Terminal

In this step, the trainer, operating TeleShaper computer 530 via training terminal 535, initiates the training mode of the TeleShaper application 570.

Step 620: Exercising Host Computer with Sample Values

In this step, the trainer, operating TeleShaper application 570 via training terminal 535, enters a sample value from the list of sample data values defined in step 606 and operates host application 560 or remote host application 565 with the sample data value. Host application 560 or remote host application 565 produces resultant output data.

Step 630: Storing Output from Host Computer

In this step, TeleShaper application 570 stores output data from host application 560 or remote host application 565 to auxiliary storage device 542.

Step 660: Completed Business Process?

In this step, the trainer determines if TeleShaper system 500 is fully trained to accommodate the business processes associated with the transfer of data from host application 560 (or remote host application 565) and auxiliary storage device 542. If no, process 600 returns to step 620; if yes, process 600 proceeds to step 670.

Step 670: Additional Sample Data Values?

In this step, the trainer determines if there are additional sample data values from that defined in step 606. If yes, process 600 returns to step 620; if no, process 600 ends.

During the step 606 of process 600, two types of sample data are used to train TeleShaper system 500: exception data and non-exception data. Exception data is data that causes exceptions in the business logic in one or more host applications 560 or remote host applications 565. During the training sequence embodied in process 600, TeleShaper application 570 may be trained to accommodate exception data in an appropriate manner. For example, TeleShaper application 570 may be trained to create an exception report and store it on auxiliary storage device 542 for later review or it may be trained to access additional data residing on auxiliary storage device 542 or within other aspects of host applications 560 or remote host applications 565 to find missing data.

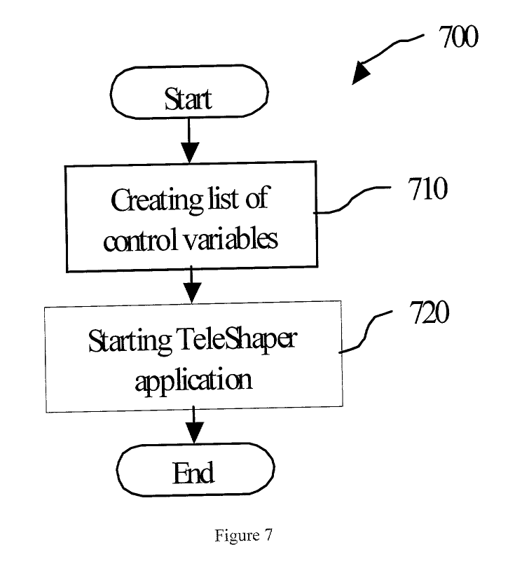

A method of using TeleShaper system 500 to migrate data from an existing application to a storage format accessible to other applications is now described with reference to FIG. 7. Process 700 presumes that training process 600 has been completed and the results of process 600 have been stored on shaper rule set storage device 540.

Step 710: Creating List of Control Variables

In this step, the trainer, using training terminal 535, defines a list of variables via TeleShaper computer 530. TeleShaper application stores the variables on auxiliary data storage device 542.

Step 720: Starting TeleShaper Application

In this step, the trainer, using training terminal 535, starts TeleShaper application 570. TeleShaper application 570 surveys the list of control variables defined in step 710 and executes the host applications as trained during process 600.

Process 700 terminates after step 720.

A method of training TeleShaper system 500 to pre-fetch a list of control values to use in the method of process 700 is now described with reference again to FIG. 4.

Step 404: Defining Control Variable

In this step, the trainer, operating TeleShaper computer 530 via training terminal 535, defines a text file that contains the control variable associated with each step embodied in the business logic of either host application 560 or remote host application 565. There may be two or more control variables. The control variable identifies the data to be transferred between host application 560 and auxiliary storage device 542. For example, a control variable named SSN may be used to store social security numbers. TeleShaper computer 530 stores the control variable on shaper rule set storage device 540.

Step 410: Starting TeleShaper Application in Training Mode

In this step, the trainer, user training terminal 535, starts TeleShaper application 570 in training mode.

Step 420: Exercising host application to access control values

In this step, the trainer, using training terminal 535, exercises host application 560 to generate a list of control values. For example, host application 560 might have a query screen where a customer list is displayed. In this case, the customers in the list are the control values.

Step 430: Storing Control Values

In this step, TeleShaper application 570 stores the list of control values in auxiliary storage device 542.

Process 400 terminates after step 430.

The results of process 400 may be used in step 710 of process 700 (described in FIG. 7). By directly obtaining the list of control variables from host application 560 or remote host application 565, process 400 obviates the need for the trainer to manually generate the list of control values in process 700. For example, process 400 would be useful in the case where it is necessary to transfer all of the client data from one bank's computer system to another bank's computer system. In this case, process 400 would automatically generate all of the control variables necessary for account transfer. Process 400 can be performed multiple times to transfer different types of data, such as client names, client addresses, and account balances.

### Third Embodiment: Migrating Data From a Storage Format to an Existing Application that Cannot Otherwise Access the Data

In an embodiment similar to the preceding, the present invention is a system for and method of automatically transferring data stored in a particular storage format to an existing application that cannot otherwise access the data. The system is able to monitor and reinterpret the data streams associated with one or more existing applications and, according to rules established during a training sequence, programmatically reformat and migrate the data from an auxiliary database to one or more existing applications.

A system corresponding to this embodiment may be configured identically to that of the previous embodiment, as depicted in FIG. 5. In this embodiment, however, host computer 510 is any computer that contains data to be transferred from auxiliary storage device 542. TeleShaper application 570 allows the migration of data from auxiliary storage device 542 to host application 560 or remote host application 565.

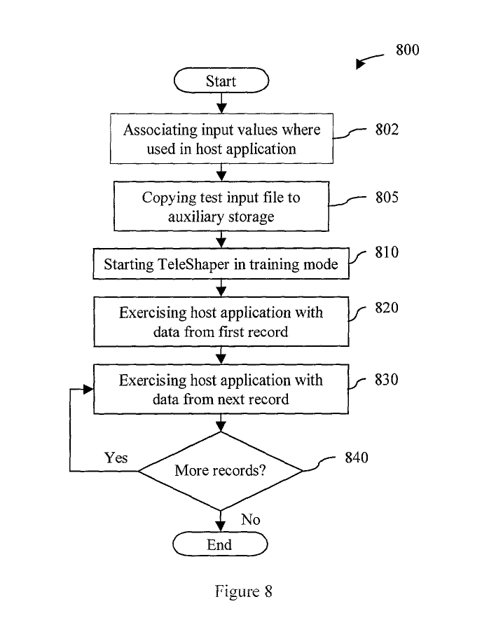

A method of training TeleShaper system 500 to transfer data from a storage format to an existing application that cannot otherwise access the data is now described with reference to FIG. 8.

Step 802: Associating Input Values Where Used in Host Application

In this step, the trainer, assessing the layout of an input file within auxiliary storage device 542, outlines where data will be entered into host application 560 or remote host application 565. This is an abstract design step.

Step 805. Copying Test Input File to Auxiliary Storage

In this step, the trainer, using training terminal 535, copies a test input file from a stored location to auxiliary storage device 542. The input file may be stored on the network, for example.

Step 810. Starting TeleShaper in Training Mode

In this step, the trainer, using training terminal 535, initiates TeleShaper application 570 in training mode.

Step 820: Exercising Host Application with Data From First Record

In this step, the trainer, using training terminal 535, exercises host application 560 or remote host application 565 via TeleShaper application 570 using the first record of the test input file stored on auxiliary storage device 542. During this step, TeleShaper application 570 creates a rule set that is stored on TeleShaper rule set storage device 540. The rule set is defined as the sequence of steps necessary for TeleShaper application 570 to perform a needed function.

Step 830: Exercising Host Application with Data From Next Record

In this step, TeleShaper application 570 utilizes the rule set stored on TeleShaper rule set storage device 540 to process the data from the next record of the test input file stored on auxiliary storage device 540 and enter the data into host application 560 or remote host application 565. During this step, the trainer refines the rule set stored on TeleShaper rule set storage device 540 until the proper result is attained.

Step 840: More records?

In this step, the trainer determines if there are more data records in the test input file stored in auxiliary storage device 542. If yes, process 800 returns to step 830; if no, process 800 proceeds to end.

Process 800 results in a rule set residing on TeleShaper rule set storage device 540 that is used by TeleShaper application 570 during normal running mode to migrate storage format data to an existing application.

During step 805 of process 800, two types of test data are used to train TeleShaper system 500: exception data and non-exception data. Exception data is data that causes exceptions in the business logic in one or more host applications 560 or remote host applications 565. During the training sequence embodied in process 800, TeleShaper application 570 may be trained to accommodate exception data in an appropriate manner. For example, TeleShaper application 570 may be trained to create an exception report and store it on auxiliary storage device 542 for later review or it may be trained to access additional data residing on auxiliary storage device 542 or within other aspects of host applications 560 or remote host applications 565 to find missing data.

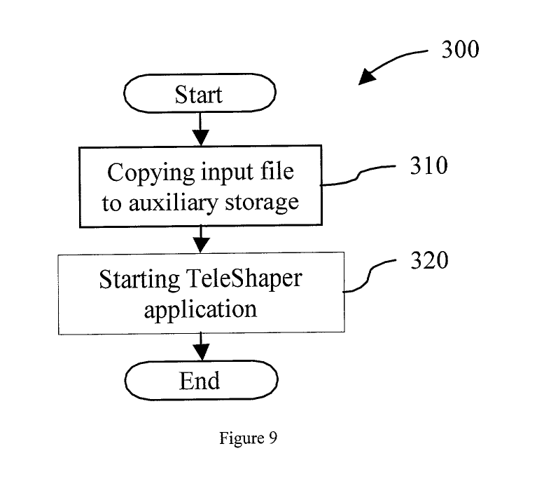

A method of using TeleShaper system 500 to migrate data from a storage format to an existing application that cannot otherwise access the data is now described with reference to FIG. 9. Process 900 presumes that training process 800 has been completed and the results of process 800 have been stored on shaper rule set storage device 540.

Step 910: Copying Input File to Auxiliary Storage

In this step, the user, using host application 560 or remote host application 565, extracts the input data file from a stored location (e.g., network, floppy disk, etc.) and copies it to auxiliary storage device 542 so that it is accessible to TeleShaper application 570. This makes the existing data storage format accessible to TeleShaper application 570.

Step 920: Starting TeleShaper Application

In this step, the user runs TeleShaper application 570 in normal run mode. TeleShaper application 570 executes the rule set created in step 820 of process 800 to import the data residing in the input file, stored on auxiliary storage device 542, to host application 560 or remote host application 565.

Process 900 terminates after step 920.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A trainable system for automatically transferring data between multiple existing applications, comprising:
a shaper computer operating a trainable user interface translator application and storing a shaper rule set and a list of control variables identifying data to be transferred;
a training terminal electrically connected to the shaper computer for establishing the shaper rule set the list of control variables during a training session;
a first host computer electrically connected to the shaper computer, and operating at least one first host application, thereby generating data streams that may be monitored by the shaper computer;
a second host computer electrically connected to the shaper computer, and operating at least one second host application, thereby generating data streams that may be monitored by the shaper computer;
wherein the shaper computer monitors the data streams of the at least one first host application and, according to the shaper rule set and list of control variables established during the training session, reinterprets and transmits automatically the data identified by the control variables to the at least one second host application.

2. The trainable system of claim 1, wherein the first host computer is a remote host computer operating a remote host application.

3. The trainable system of claim 1, wherein both the first host computer and the second host computer are remote host computers.

4. The trainable system of claim 1, wherein the first host computer and second host computer are the same computer operating the at least one first host application and at least one second host application.

5. The trainable system of claim 1, further comprising a plurality of first host computers electrically connected to the shaper computer and operating at least one first host application.

6. The trainable system of claim 1, further comprising an auxiliary storage device electrically connected to the shaper computer for storage and retrieval of training data sets to be employed during the training session.

7. The trainable system of claim 1, wherein the first host computer further comprises a first storage device containing data associated with the at least one first host application.

8. In a trainable system comprising a shaper computer operating a trainable user interface translator application and storing a shaper rule set and control variables, a training terminal electrically connected to the shaper computer, a first host computer electrically connected to the shaper computer and operating at least one first host application, and a second host computer electrically connected to the shaper computer and operating at least one second host application, a method of training the trainable system to transfer data between multiple host applications, comprising the steps of:
operating the trainable user interface translator application via the training terminal to define and store input and output variables associated with each step embodied in the business logic of the at least one first host application;
defining one or more control variables identifying data to be transferred between the at least one first host application and at least one second host application via the training terminal;
selecting sample data values for the control variables;
starting a training mode on the training terminal;
exercising the at least one first host application via the training terminal with the sample data values to obtain resultant output data, while storing the sequence of steps for exercising the at least one first host application in the shaper rule set;
storing the resultant output data in temporary storage;
exercising the at least one second host application via the training terminal with the resultant output data which may produce secondary output data, while storing the sequence of steps for exercising the at least one second host application in the shaper rule set;
storing secondary output data, if any;
determining if the trainable system is fully trained to accommodate business processes associated with transferring data between the at least one first host application and at least one second host application, and if not, reverting to the step of exercising the at least one first host application; and
determining if there are additional sample data values to process, and if so, reverting to the step of exercising the at least one first host application.

9. The method of claim 8, wherein the first host computer is a remote host computer operating a remote host application.

10. The method of claim 8, wherein both the first host computer and the second host computer are remote host computers.

11. The method of claim 8, wherein the first host computer and second host computer are the same computer operating the at least one first host application and at least one second host application.

12. The method of claim 8, wherein the trainable system further comprises a plurality of first host computers electrically connected to the shaper computer and operating at least one first host application.

13. The method of claim 8, wherein the trainable system further comprises an auxiliary storage device electrically connected to the shaper computer for storage and retrieval of training data sets to be employed during the training session.

14. The method of claim 8, wherein the first host computer further comprises a first storage device containing data associated with the at least one first host application.

15. In a trained system comprising a shaper computer operating a trainable user interface translator application and storing a shaper rule set, a training terminal electrically connected to the shaper computer, a first host computer electrically connected to the shaper computer and operating at least one first host application, and a second host computer electrically connected to the shaper computer and operating at least one second host application, a method of using the trained system to automatically transfer data between multiple host applications, comprising the steps of
generating and storing via the training terminal a list of control variables identifying data to be transferred from the at least one first host application to the at least one second host application; and
starting via the training terminal the trainable user interface application in automatic mode, causing the trainable user interface translator application to survey the list of control variables and exercise the at least one first host application and at least one second host application in accordance with the shaper rule set, thereby transferring the identified data.

16. In a trainable system comprising a shaper computer operating a trainable user interface translator application and storing a shaper rule set, a training terminal electrically connected to the shaper computer, a first host computer electrically connected to the shaper computer and operating at least one first host application, and a second host computer electrically connected to the shaper computer and operating at least one second host application, a method of training the trainable system to generate a list of control values, comprising the steps of:
defining and storing via the training terminal one or more control variables associated with each step embodied in the business logic of either the at least one first host application or at least one second host application;
starting via the training terminal the trainable user interface translator application in training mode;
exercising via the training terminal the at least one first host application to generate a list of control variables; and
storing the list of control variables.

17. The method of claim 16, wherein the list of control variables are stored on an auxiliary storage device.

18. A trainable system for migrating data from an existing application to a storage format accessible to other applications, comprising:
a shaper computer operating a trainable user interface translator application and storing a shaper rule set and a list of control variables identifying data to be transferred;
a training terminal electrically connected to the shaper computer for establishing the shaper rule set the list of control variables during a training session;
a host computer electrically connected to the shaper computer, and operating at least one host application, thereby generating data streams that may be monitored by the shaper computer; an auxiliary storage device electrically connected to the shaper computer for receiving data transferred from the at least one host application;
wherein the shaper computer monitors the data streams of the at least one host application and, according to the shaper rule set and list of control variables established during the training session, reinterprets and transmits automatically the data identified by the control variables to the auxiliary storage device.

19. The trainable system of claim 18, wherein the host computer is a remote host computer operating a remote host application.

20. In a trainable system comprising a shaper computer operating a trainable user interface translator application and storing a shaper rule set and control variables, a training terminal electrically connected to the shaper computer, a host computer electrically connected to the shaper computer and operating at least one host application, and an auxiliary storage device electrically connected to the shaper computer, a method of training the trainable system to migrate data from an existing application to a storage format accessible to other applications, comprising the steps of:
operating the trainable user interface translator application via the training terminal to define and store input and output variables associated with each step embodied in the business logic of the at least one host application;
defining and storing via the training terminal one or more control variables identifying data to be transferred between the at least one host application and the auxiliary storage device;
selecting sample data values for the control variables;
starting the user interface translator application in training mode;
exercising the at least one host application via the training terminal with the sample data values to obtain resultant output data, while storing the sequence of steps for exercising the at least one host application in the shaper rule set;
storing the resultant output data in the auxiliary storage device;
determining if the trainable system is fully trained to accommodate business processes associated with migrating data between the at least one host application and the auxiliary storage device, and if not, reverting to the step of exercising the at least one host application; and
determining if there are additional sample data values to process, and if so, reverting to the step of exercising the at least one host application.

21. The method of claim 20, wherein the host computer is a remote host computer operating at least one remote host application.

22. In a trained system comprising a shaper computer operating a trainable user interface translator application and storing a shaper rule set and control variables, a training terminal electrically connected to the shaper computer, a host computer electrically connected to the shaper computer and operating at least one host application, and an auxiliary storage device electrically connected to the shaper computer, a method of using the trained system to migrate data from an existing application to a storage format accessible to other applications, comprising the steps of:
generating and storing on the auxiliary storage device via the training terminal a list of control variables identifying data to be transferred from the at least one host application to the auxiliary storage device; and
starting via the training terminal the trainable user interface application in automatic mode, causing the trainable user interface translator application to survey the list of control variables and exercise the at least one first host application and at least one second host application in accordance with the shaper rule set, thereby migrating the identified data.

23. The method of claim 22, wherein the host computer is a remote host computer operating at least one remote host application.

24. In a trainable system comprising a shaper computer operating a trainable user interface translator application and storing a shaper rule set, a training terminal electrically connected to the shaper computer, a host computer electrically connected to the shaper computer and operating at least one host application, and an auxiliary storage device electrically connected to the shaper computer, a method of training the trainable system to pre-fetch a list of control values, comprising the steps of:
defining and storing via the training terminal one or more control variables associated with each step embodied in the business logic of the at least one host application and identifying the data to be migrated;
starting via the training terminal the trainable user interface translator application in training mode;
exercising via the training terminal the at least one host application to generate a list of control variables; and
storing the list of control variables in the auxiliary storage device.

25. The method of claim 24, wherein the host computer is a remote host computer operating at least one remote host application.

26. A trainable system for migrating data from a particular storage format to an existing application that cannot otherwise access the data:
a shaper computer operating a trainable user interface translator application and storing a shaper rule set and a list of control variables identifying data to be transferred;
a training terminal electrically connected to the shaper computer for establishing the shaper rule set the list of control variables during a training session;
a host computer electrically connected to the shaper computer, and operating at least one first host application;
an auxiliary storage device electrically connected to the shaper computer, from which input data files may be retrieved by the shaper computer, the data files being otherwise inaccessible to the at least one host application;
wherein the shaper computer, according to the shaper rule set established during the training session, retrieves input data files from the auxiliary storage device and migrates the input data files to the at least one host application.

27. The trainable system of claim 26, wherein the host computer is a remote host computer operating at least one remote host application.

28. In a trainable system comprising a shaper computer operating a trainable user interface translator application and storing a shaper rule set, a training terminal electrically connected to the shaper computer, a host computer electrically connected to the shaper computer and operating at least one host application, and an auxiliary storage device electrically connected to the shaper computer, a method of training the trainable system to migrate data from a particular storage format to an existing application, comprising the steps of:
associating input values where used in the host application;
copying via the training terminal a test input file from a stored location to the auxiliary storage device;
starting the trainable user interface translator application in training mode;
exercising the at least one host application via the training terminal with a first record of the test input file to migrate the first record to the at least one host application, while recording the sequence of steps for exercising the at least one host application in the shaper rule set;
exercising the at least one host application via the training terminal with a next record of the test input file to migrate the next record to the at least one host application, utilizing and refining the shaper rule set to migrate the next record; and
determining if there are additional records in the test input file, and if so, reverting to the previous step.

29. The method of claim 28, wherein the host computer is a remote host computer operating at least one remote host application.

30. In a trained system comprising a shaper computer operating a trainable user interface translator application and storing a shaper rule set, a training terminal electrically connected to the shaper computer, a host computer electrically connected to the shaper computer and operating at least one host application, and an auxiliary storage device electrically connected to the shaper computer, a method of using the trained system of the first or second aspects to migrate data from a particular storage format to an existing application, including the steps:
copying an input file from a source to the auxiliary storage device; and
starting the trainable user interface translator application in a normal run mode, causing the trainable user interface translator application to execute the shaper rule set thereby migrating the input file from the auxiliary storage device to the at least one host application.
